(19) United States
(12) Patent Application Publication
(10) Pub. No.: US 2022/0194464 A1
(43) Pub. Date: Jun. 23, 2022

(54) METHOD FOR CONTROLLING A STEER-BY-WIRE STEERING SYSTEM AND STEER-BY-WIRE STEERING SYSTEM FOR A MOTOR VEHICLE

(71) Applicants: thyssenkrupp Presta AG, Eschen (LI); thyssenkrupp AG, Essen (DE)

(72) Inventor: Marco DÄHLER, St. Gallen (CH)

(73) Assignees: thyssenkrupp Presta AG, Eschen (LI); thyssenkrupp AG, Essen (DE)

(21) Appl. No.: 17/601,157

(22) PCT Filed: Mar. 27, 2020
(86) PCT No.: PCT/EP2020/058660

§ 371 Date: Oct. 4, 2021

(30) Foreign Application Priority Data
Apr. 4, 2019 (DE) 10 2019 204 857.9

(51) Int. Cl. B62D 6/00; B62D 5/04

(52) U.S. Cl. CPC B62D 6/00; B62D 5/04

(57) ABSTRACT

A method can be used to control a steer-by-wire steering system for a motor vehicle. According to the method, a steering shaft sensor arranged on a steering shaft detects a steering angle input by a driver via a steering control element and a control unit based on a function of the detected steering angle and specifies a wheel steering angle for an electronically controlled steering actuator acting on at least one steered wheel. The control unit then calculates the wheel steering angle taking into account a specifiable correction angle. A steer-by-wire steering system can also be used to execute the method.

### DESCRIPTION

The invention relates to a method for controlling a steer-by-wire steering system according to the preamble of claim 1 and a steer-by-wire steering system for a motor vehicle according to the preamble of claim 10.

In steer-by-wire steering systems for motor vehicles, there is no mechanical connection any more between a steering wheel operated by the driver—the steering control element—and the steered wheels. Instead, the position of the steered wheels is adjusted by an electronically controlled steering actuator in order to guide the vehicle on the desired path. For this purpose, a steering shaft sensor connected to the steering shaft provides a nominal position signal which represents the steering intention of the driver. The steering actuator is then actuated via a position controller with sufficient power and bandwidth in such a manner with a torque request signal that the steered wheels are adjusted into the nominal position. In this case, it is desirable that control of the steering system is performed in such a manner that a familiar steering sensation is provided to the driver.

In the case of conventional steering systems, the steering line has a certain rigidity. This is composed substantially jointly from the steering shaft, the torsion bar and a few further stiffnesses. In a steer-by-wire steering system, for technical reasons, the steering stiffness is, however, very stiff since the mechanical elements which substantially lead to reduced stiffness are not present.

U.S. 2018/0079447 A1 discloses a control for a steer-by-wire steering system, in the case of which the steering system stops the driver from moving the steering wheel beyond a virtual steering stop. It is, however, disadvantageous for the sensation of the driver that this steering system responds significantly more quickly to a steering of the driver than conventional steering systems since no mechanical elements are present which lead to a reduced stiffness of the steering column and as a result of this impair the transmission of the driver's steering desire to the steered wheels.

The object of the present invention is therefore to indicate a method for controlling a steer-by-wire steering system and a steer-by-wire steering system for a motor vehicle which improves the steering sensation for the driver.

This object is achieved by a method for controlling a steer-by-wire steering system with the features of claim 1 and a steer-by-wire steering system with the features of claim 10. Advantageous further developments will become apparent from the respective subordinate claims.

As a result of this, there is indicated a method for controlling a steer-by-wire steering system for a motor vehicle, in which method a steering shaft sensor arranged on a steering shaft detects a steering angle input by the driver via a steering control element and a control unit, as a function of the detected steering angle, specifies a wheel steering angle for an electronically controlled steering actuator acting on at least one steered wheel. The control unit calculates the wheel steering angle taking into account a specifiable correction angle.

As a result of the solution according to the invention, the steering system can be equipped with an adjustable, virtual steering stiffness. Correction is preferably performed such that the at least one steered wheel lags behind an adjustment of the steering control element, for example, a rotation of a steering wheel. The steering wheel is, in the case of the same position of the at least one steered wheel, thus already adjusted further than would be the case with a steer-by-wire steering system according to the prior art. An additional angle offset is thus introduced. As a result of this, the steering system is equipped with a virtual steering stiffness which suggests a flexibility of the steering chain to the driver as is familiar to him or her from conventional steering systems.

A specifiable correction angle is preferably understood as a fixed value or a function. A value or a function further designates the term of the specifiable correction angle which can be parameterized with parameters which can be set by the driver. As a result of this, the steering stiffness can be selected so that it has different values depending on the vehicle type, for example, a sports car or a limousine, or is correspondingly adjustable by different driving modes, such as sports or comfort.

In one advantageous further development, the steering shaft sensor additionally detects a steering torque introduced into the steering shaft and the correction angle is calculated as a function of this steering torque. For example, the steering torque can be determined via a torque sensor which is operatively connected to the steering shaft. Such torque sensors are known from the prior art and can have, for example, inductive or magnetic measuring apparatuses. The use of Hall sensors is also conceivable and possible. This list of the torque sensors which are suitable for use is not restricted to the above-mentioned list.

The correction angle is preferably determined via a linear or non-linear functional relationship from the steering torque.

The electronically controlled steering actuator preferably acts on two steered wheels.

The detected steering angle is preferably changed by the correction angle and a wheel steering angle is assigned to the corrected steering angle obtained in this manner, which wheel steering angle is specified to the steering actuator. Alternatively, however, the detected steering angle can also be converted directly into an assigned wheel steering angle which is then changed by the correction angle.

The steering actuator can preferably comprise an electric motor, particularly preferably a synchronous machine.

According to one preferred embodiment, the correction angle is calculated as a function of a load engaging on the steering actuator. In the case of a toothed rack steering, the load is transmitted in the form of a toothed rack force via the toothed rack to the steering actuator. The toothed rack force can then be determined, for example, via the motor current of the steering actuator, or via a separate sensor. The correction angle is preferably determined via a linear or non-linear functional relationship from the load. In the case of steering systems which do not have a toothed rack, such as a single-wheel steering, the load engaging on the steering actuator can be, for example, a load torque or a load force, on the basis of which the correction angle is calculated. The load can, for example, be a wheel pivot load which acts on the steerable wheel in the wheel steering angle direction.

In particular, it can alternatively or additionally be provided that the steering torque or the load is multiplied by a selectable stiffness parameter in order to calculate the correction angle. The stiffness parameter is preferably selected in such a manner that the correction angle corresponds to a spring stiffness of the steering shaft in the range from 0.5 to 4 Nm per angular degree, particularly preferably from 1 to 3 Nm per angular degree and very particularly preferably from 1.5 to 2.5 Nm per angular degree. As a result of this, a virtual steering stiffness of the steering system is generated which lies in a range which is familiar to the driver from conventional steering systems.

For example, the correction angle can also, i.e. alternatively or additionally, be calculated as a function of a driving speed of the motor vehicle and/or as a function of the detected steering angle and/or the steering angle speed and/or the carriageway conditions and/or the driving mode. As a result of this, for example, in the case of high driving speeds, it is possible to set a higher flexibility of the steering system, while more direct steering is performed in the case of low driving speeds.

The steering properties can thus be adapted to the respective driving situation, such as, for example, motorway driving or parking. It is also conceivable that further measured or estimated or transmitted parameters, such as, for example, the carriageway conditions, are taken into account in the calculation of the correction angle. As a result of these measures, the hysteresis-inertia sensation can be adjusted.

It can furthermore be provided to restrict the correction angle to a selectable angle interval. As a result of the restriction of the correction angle to an angle interval, the effect of the overload protection of the torsion rod present in conventional steering systems can be simulated in the steer-by-wire steering system. The selectable angle internal is therefore preferably restricted by a minimum and a maximum correction angle which correspond to a minimum and a maximum torsion angle of the torsion rod. The angle interval is preferably selected symmetrically to zero. The angle interval is preferably between ±6 angular degree and ±18angular degree, particularly preferably between ±10 angular degree and ±15 angular degree.

In the case of steer-by-wire steering systems, it can arise that the steering actuator, as a result of a large number of rapid changes in direction, for example, when driving on a zigzag road, is put under strain such that an undesired increase in temperature of the steering actuator arises so that it overheats and is impaired in terms of its function. The driver does not perceive this as a result of the non-existent mechanical coupling between the steering control element and the at least one steered wheel or only when the steering actuator fails to perform its task.

Thanks to the solution according to the invention, the correction angle can be adapted as a function of a determined temperature of the steering actuator such that the steering stiffness is further reduced in accordance with how high the temperature is. This is preferably performed if the temperature exceeds a specific threshold value. The correction angle is then particularly preferably changed suddenly such that the driver also perceives this, but so that he or she always has the feeling of being in command of the motor vehicle. Alternatively or additionally, a feedback actuator coupled to the steering shaft can provide the driver with delayed feedback so that this behavior is perceived by the driver as more spongy and softer (reduced steering stiffness) than in normal driving operation. It is thus suggested to the driver that a critical state is present and he or she can safely put the motor vehicle out of service. It can further be provided that, if the temperature of the steering actuator exceeds a fixed threshold value, a warning light and/or a warning sound is activated which warns the driver of an overheating of the steering actuator and asks him or her to put the vehicle out of service.

In terms of the device, the object is achieved by a steer-by-wire steering system fora motor vehicle with a steering shaft sensor arranged on a steering shaft, an electronically controllable steering actuator acting on at least one steered wheel and a control unit which is configured to specify a wheel steering angle for the steering actuator as a function of a steering angle detected by the steering shaft sensor, wherein the steering system is configured to execute the above-described method according to the invention.

Further configurations of the invention can be inferred from the following description and the subordinate claims.

The invention is described in greater detail below on the basis of the exemplary embodiments represented in the attached illustrations.

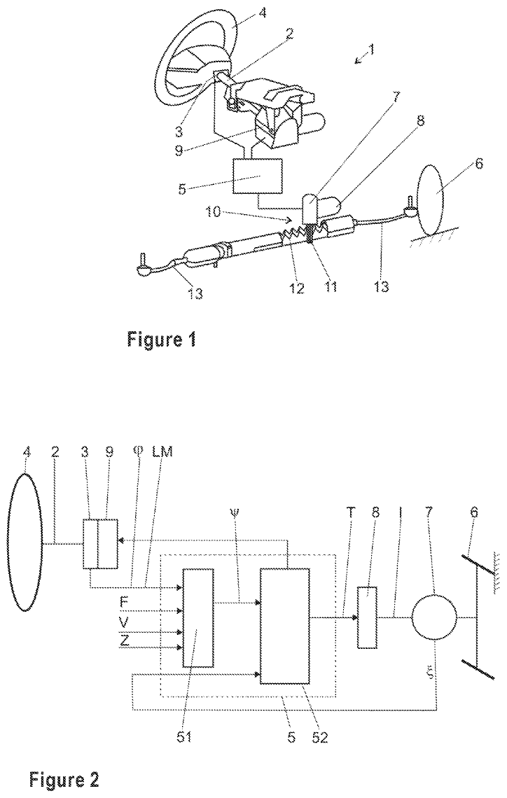

FIG. 1 schematically shows an exemplary embodiment of the steer-by-wire steering system according to the invention,

FIG. 2 schematically shows the structure of the steering system and the associated control unit according to the exemplary embodiment according to FIG. 1 in a block diagram,

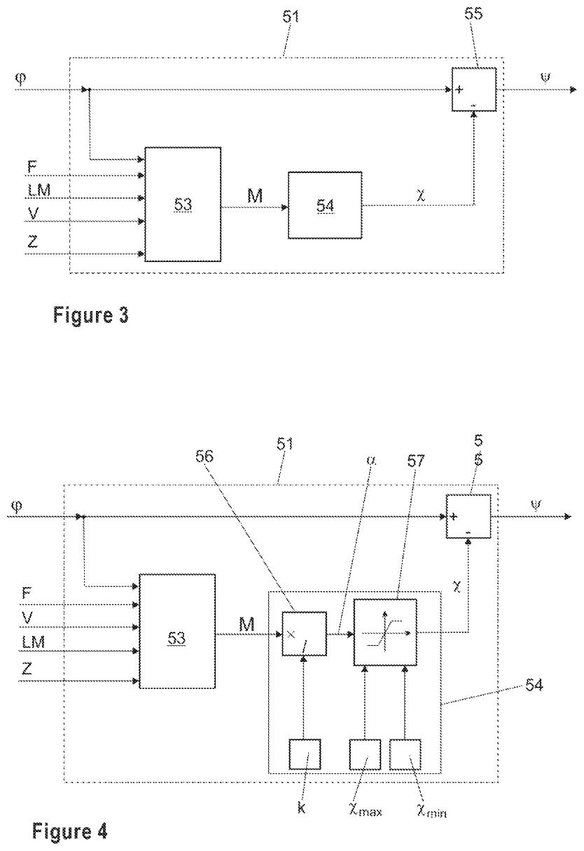

FIG. 3 schematically shows an example of the structure of the calculation unit of the control unit according to the exemplary embodiment according to FIGS. 1 and 2,

FIG. 4 schematically shows an example of the structure of the correction angle determination unit of the calculation unit according to FIG. 3,

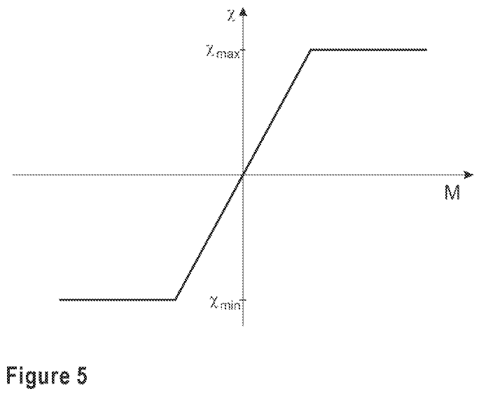

FIG. 5 shows by way of example a characteristic curve of the correction angle determination unit according to FIG. 4.

The structure of a steer-by-wire steering system 1 for a motor vehicle according to a first exemplaty embodiment of the invention is represented schematically in figure (FIG. 1. Steer-by-wire steering system 1 has a steering control element 4 connected via a steering shaft 2 to a feedback actuator 9 in the form of a steering wheel. Steering system 1 further comprises an electronically controllable steering actuator 7 acting on two steered wheels 6 with a control device 8. Steering actuator 7 is connected via a steering gear 10 to a toothed rack 12. Steering gear 10 can comprise, for example, a pinion 11 which is in engagement with toothed rack 12. The translations of toothed rack 12 brought about by steering actuator 7 are transmitted via tie rods 13 to steered wheels 6 in order to adjust a wheel steering angle Ψ. Steer-by-wire steering system 1 finally comprises a control unit 5 which obtains steering angle φ of steering shaft 2 detected by a steering shaft sensor 3 as an input variable and specifies to steering actuator 7 an associated wheel steering angle Ψ as an output variable. Steering shaft sensor 3 can additionally be configured to detect a steering torque LM introduced into steering shaft 2. Steering shaft sensor 3 can either be formed as a separate sensor or integrated into feedback actuator 9. Control unit 5 furthermore serves to detect feedback effects from the carriageway which engage on steering actuator 7 as loads F, for example, in the form of a toothed rack force, and actuate feedback actuator 9 as a function of these loads F so that the driver feels the feedback effects from the carriageway in a familiar manner at steering control element 4.

FIG. 2 schematically shows the structure of steer-by-wire steering system 1 according to FIG. 1 as a block diagram. The steering position input by the driver at steering control element 4 is transmitted via steering shaft 2 to steering shaft sensor 3 which supplies measured steering angle φ and measured steering torque LM to a calculation unit 51 in control unit 5. Steering shaft sensor 3 comprises a steering angle sensor and a torque sensor which can be formed individually or as a measuring unit. Calculation unit 51 has as further input variables load F lying against toothed rack 12, vehicle speed v, as well as further state variables Z which characterize the vehicle state. From these input variables, calculation unit 51 calculates wheel steering angle Ψ and outputs this to a position controller 52 of control unit 5. The calculation of wheel steering angle Ψ is preferably performed taking into account a correction angle χ, the determination of which is preferably performed on the basis of steering torque LM and/or a load F and/or a driving speed v of the motor vehicle or other parameters, such as carriageway conditions, etc.. These variables can be measured, estimated or otherwise determined or identified or communicated.

Position controller 52 is provided to determine, from wheel steering angle 105 (nominal value) and an actual actuating angle ξ, a torque request signal T for steering actuator 7 which is suitable for adjusting wheel steering angle Ψ to steered wheels 6. Actual actuating angle ξ can be determined, for example, via a rotor position sensor at steering actuator 7. Alternatively, a separate sensor can be provided to detect actual actuating angle ξ, for example, in the form of a toothed rack position. Torque request signal T is output to a control device 8 of steering actuator 7 which converts this into associated motor currents I in order to actuate steering actuator 7.

Position controller 52 is furthermore provided to output a feedback signal for feedback actuator 9 on the basis at least of actuating angle ξ and wheel steering angle Ψ. The feedback signal can preferably be specified as a function of—in particular proportional to—the present position deviation between wheel steering angle Ψ and actuating angle ξ. The feedback signal can furthermore be dependent on load F.

FIG. 3 shows by way of example the structure of calculation unit 51 as a block diagram. Steering angle φ measured by steering shaft sensor 3 is therein supplied to a subtracter 55 and a steering torque determination unit 53. Steering torque determination unit 53 receives as further input variables steering torque LM measured by steering shaft sensor 3, load F, driving speed v, as well as further state variables Z which characterize the vehicle state. On the basis of these input variables, steering torque determination unit 53 calculates a virtual steering shaft torque M which is output to a correction angle determination unit 54. Correction angle determination unit 54 calculates, on the basis of virtual steering shaft torque M, a correction angle χ which is supplied to subtracter 55.

In the simplest case, virtual steering shaft torque M can be equal to measured steering torque LM. In other embodiments, measured steering torque LM can be offset by means of the remaining input variables of steering torque determination unit 53 to arrive at a virtual steering shaft torque M which is adapted to the driving situation. In further embodiments, virtual steering shaft torque M is calculated without taking into account measured steering torque LM.

Subtracter 55 calculates wheel steering angle Ψ from steering angle φ and correction angle χ. For example, the difference between steering angle φ and correction angle χ is assigned an assigned wheel steering angle Ψ in accordance with an assignment function. Alternatively, however, a preliminary wheel steering angle can also initially be assigned to steering angle φ, which preliminary wheel steering angle is then corrected by deducting correction angle χ from wheel steering angle Ψ.

FIG. 4 shows by way of example the structure of calculation unit 51 with a detailed representation of correction angle determination unit 54 as a block diagram. FIG. 4 shows a preferred embodiment, in the case of which a virtual steering shaft torque M is determined on the basis of load F and/or vehicle speed v, which virtual steering shaft torque M is converted by means of a stiffness parameter k into a preliminary correction angle α. Stiffness parameter k can be selected as a function of steering torque LM, steering angle φ, steering angle speed, vehicle speed, for example, by a function in which the stated variables serve as an input value. Depending on the embodiment, stiffness parameter k can also be represented in a characteristic field, or be acted upon as a function of the states with amplification factors. To this end, virtual steering shaft torque M is multiplied in a multiplier 56 by stiffness parameter k in correction angle determination unit 54. Virtual steering shaft torque M is preferably proportional to load F so that in this case, in order to calculate correction angle χ, load F or steering torque LM is multiplied by a selectable stiffness parameter k. The stiffness parameter is preferably selected so that the resultant virtual steering stiffness corresponds to a spring stiffness of steering shaft 2 in the range from 0.5 to 4 Nm per angular degree. This corresponds to the normal spring stiffness of a real torsion rod.

In the case of a real torsion rod arrangement, angle α would be the torsion angle. In the case of a real torsion rod arrangement, the torsion angle is restricted by an overload protection device. It is therefore preferably provided to restrict preliminary correction angle α subsequently in a restricter 57 to a selectable angle interval. Insofar as preliminary correction angle a lies within this interval, correction angle χ is equal to preliminary correction angle α. Insofar as preliminary correction angle α lies outside the angle interval, correction angle χ is fixed to a minimum correction angle χmin or a maximum correction angle χmax. The correction angle restricted in such a manner is output as correction angle χto subtracter 55.

The statements in relation to FIG. 3 otherwise correspondingly apply.

FIG. 5 schematically shows the characteristic curve of correction angle determination unit 54 according to FIG. 4. In a central torque range, a correction angle χ is assigned to virtual steering shaft torque M according to a linear relationship. Stiffness parameter k forms in this case the proportionality constant. In the case of virtual torques M outside the angle interval of restricter 57, correction angle χ is restricted to minimum or the maximum admissible correction angle χmin, χmax. As shown in FIG. 5, the angle interval is preferably selected to be symmetrical about zero.

When calculating correction angle χ, in contrast to the exemplary embodiment represented in FIGS. 1 to 5, many variants are conceivable. For example, restricter 57 can be dispensed with. Moreover, in one simplified embodiment, correction angle 102 can be specified as a constant, or calculated exclusively as a variable which is proportional to load F or steering torque LM. Finally, it is conceivable that virtual steering shaft torque M is calculated as a function of load F and the remaining state variables Z, driving speed v and/or steering angle φ are included in the calculation of a stiffness parameter k adapted to the driving situation. Minimum and/or maximum admissible correction angle χmin, χmax can also be specified as a function of the remaining state variables Z, driving speed v and/or steering angle φ and/or steering torque LM. Finally, partial stiffnesses which are added together to yield a total connection angle can also be calculated on the basis of individual state variables Z, v, φ.

### LIST OF REFERENCE NUMBERS

1 Steer-by-wire steering system

2 Steering shaft

3 Steering shaft sensor

4 Steering control element

5 Control unit

6 Steered wheels

7 Steering actuator

8 Control device

9 Feedback actuator

10 Steering gear

11 Pinion

12 Toothed rack

13 Tie rod

51 Calculation unit

52 Position controller

53 Steering torque determination unit

54 Correction angle determination unit

55 Subtracter

56 Multiplier

57 Restricter

φ Steering angle

χ Correction angle

Ψ Wheel steering angle

α Preliminary correction angle

χmin Minimum correction angle

χmax Maximum correction angle

ξ Actual actuating angle

F Load

M Virtual steering shaft torque

v Driving speed

k Stiffness parameter

T Torque request signal

I Motor currents

LM Steering torque

Z State variable

1.-10. (canceled).

11. A method for controlling a steer-by-wire steering system for a motor vehicle, comprising:
detecting with a steering shaft sensor disposed on a steering shaft a steering angle input by a driver via a steering control element; and
specifying with a control unit, as a function of the steering angle that is detected, a wheel steering angle for an electronically controlled steering actuator acting on a steered wheel, wherein the control unit takes into account a specifiable correction angle when calculating the wheel steering angle.

12. The method of claim 11 comprising detecting with the steering shaft sensor a steering torque introduced into the steering shaft, wherein the specifiable correction angle is calculated as a function of the steering torque.

13. The method of claim 12 comprising multiplying the steering torque by a selectable stiffness parameter to calculate the specifiable correction angle.

14. The method of claim 11 comprising calculating the specifiable correction angle as a function of a load that engages on the electronically controlled steering actuator.

15. The method of claim 14 comprising multiplying the load by a selectable stiffness parameter to calculate the specifiable correction angle.

16. The method of claim 15 comprising selecting the selectable stiffness parameter such that the specifiable correction angle corresponds to a spring stiffness of the steering shaft in a range of 0.5 to 4 Nm per angular degree.

17. The method of claim 11 comprising calculating the specifiable correction angle as a function of a driving speed of the motor vehicle.

18. The method of claim 11 comprising calculating the specifiable correction angle as a function of the steering angle that is detected.

19. The method of claim 11 comprising restricting the specifiable correction angle to a selectable angle interval.

20. A steer-by-wire steering system for a motor vehicle, comprising:
a steering shaft sensor disposed on a steering shaft;
an electronically controllable steering actuator acting on a steered wheel; and
a control unit that is configured to specify a wheel steering angle for the electronically controllable steering actuator as a function of a steering angle detected by the steering shaft sensor,
wherein the steer-by-wire steering system is configured to execute the method of claim 11.
